(19) United States
(12) Patent Application Publication
(10) Pub. No.: US 2005/0215200 A1
(43) Pub. Date: Sep. 29, 2005

(54) Method and system for implementing a vehicle WiFi access point gateway

(75) Inventor: Christopher L. Oesterling, Troy, MI (US)

Correspondence Address: General Motors Corporation;Legal Staff, Mail Code 482-C23-B21, 300 Renaissance Center, P.O. Box 300, Detroit, MI, 48265-3000, US

(73) Assignee: General Motors Corporation

(21) Appl. No.: 10/809,083

(22) Filed: Mar. 25, 2004

(51) Int. Cl. H04B 7/00

(52) U.S. Cl. 455/66.1

(57) ABSTRACT

The present invention provides a method of operating a vehicle telematics device as a communication gateway. The method includes detecting a wireless access point with a vehicle telematics device, establishing a communication gateway between the detected wireless access point and a service provider utilizing the vehicle telematics device, and communicating data between the wireless access point and the service provider via the communication gateway. The step of detecting the wireless access point may include transmitting a polling message from the telematics device and receiving a response, generated by the wireless access point, to the polling message. The step of establishing the communication gateway between the detected wireless access point and the service provider may include establishing communication between the communication gateway and the detected wireless access point utilizing a first communication protocol, and establishing communication between the communication gateway and the service provider utilizing a second communication protocol.

### FIELD OF THE INVENTION

This invention relates generally to wireless communications. More specifically, the invention relates to a method and system for implementing a vehicle WiFi access point gateway.

### BACKGROUND OF THE INVENTION

The opportunity to utilize wireless features is ever increasing as cellular transceivers are being transformed into entertainment as well as communication platforms. One such cellular transceiver is a wireless feature included within wireless vehicle communication and networking services for a mobile vehicle.

Typically, wireless systems within mobile vehicles (e.g., telematics units) provide voice communication. Recently, these wireless systems have been utilized to update systems within telematics units such as, for example, radio station presets.

Cellular transceivers operate within communication systems such as, for example, a telematics unit within a mobile vehicle operating within a mobile vehicle communication system (MVCS). Unfortunately, while telematics units within mobile vehicles are beneficial to both the customer as well as the manufacturer, not all customers choose to contract a telematics unit option at the time of the mobile vehicle purchase. Typically, this choice results in the vehicle being sold without the telematics unit and its aforementioned benefits.

The present invention advances the state of the art in cellular transceivers.

### SUMMARY OF THE INVENTION

One aspect of the invention includes a method of operating a vehicle telematics device as a communication gateway. The method includes detecting a wireless access point with a vehicle telematics device, establishing a communication gateway between the detected wireless access point and a service provider utilizing the vehicle telematics device, and communicating data between the wireless access point and the service provider via the communication gateway.

In accordance with another aspect of the invention, a computer readable medium storing a computer program includes computer readable code for detecting a wireless access point with a vehicle telematics device, computer readable code for establishing a communication gateway between the detected wireless access point and a service provider utilizing the vehicle telematics device, and computer readable code for communicating data between the wireless access point and the service provider via the communication gateway.

In accordance with yet another aspect of the invention, a system for operating a vehicle telematics device as a communication gateway is provided. The system includes means for detecting a wireless access point with a vehicle telematics device. Means for establishing a communication gateway between the detected wireless access point and a service provider utilizing the vehicle telematics device is provided. Means for communicating data between the wireless access point and the service provider via the communication gateway is also provided.

The aforementioned, and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 illustrates an operating environment for implementing wireless communication within a mobile vehicle communication system;

FIG. 2 is a block diagram of a telematics based system in accordance with an embodiment of the present invention; and

FIG. 3 is a flow diagram of one embodiment of a method of operating a vehicle telematics device as a communication gateway, in accordance with the present invention.

### DETAILED DESCRIPTION OF THE DRAWINGS

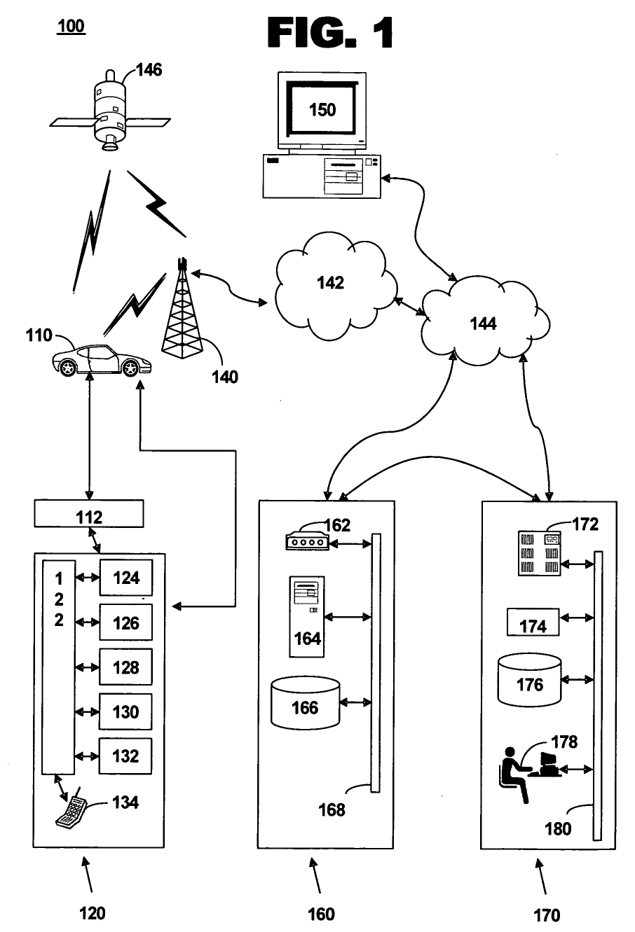

FIG. 1 illustrates one embodiment of a system for data transmission over a wireless communication system, in accordance with the present invention at 100. Mobile vehicle communication system (MVCS) 100 includes a mobile vehicle communication unit (MVCU) 110, a vehicle communication network 112, a telematics unit 120, one or more wireless carrier systems 140, one or more communication networks 142, one or more land networks 144, one or more satellite broadcast systems 146, one or more client, personal, or user computers 150, one or more web-hosting portals 160, and one or more call centers 170. In one embodiment, MVCU 110 is implemented as a mobile vehicle equipped with suitable hardware and software for transmitting and receiving voice and data communications. MVCS 100 may include additional components not relevant to the present discussion. Mobile vehicle communication systems and telematics units are known in the art.

MVCU 110 is also referred to as a mobile vehicle in the discussion below. In operation, MVCU 110 may be implemented as a motor vehicle, a marine vehicle, or as an aircraft. MVCU 110 may include additional components not relevant to the present discussion.

MVCU 110, via a vehicle communication network 112, sends signals to various units of equipment and systems (detailed below) within MVCU 110 to perform various functions such as unlocking a door, opening the trunk, setting personal comfort settings, and calling from telematics unit 120. In facilitating interactions among the various communication and electronic modules, vehicle communication network 112 utilizes network interfaces such as controller-area network (CAN), International Organization for Standardization (ISO) Standard 9141, ISO Standard 11898 for high-speed applications, ISO Standard 11519 for lower speed applications, and Society of Automotive Engineers (SAE) Standard J1850 for high-speed and lower speed applications.

MVCU 110, via telematics unit 120, sends to and receives radio transmissions from wireless carrier system 140. Wireless carrier system 140 is implemented as any suitable system for transmitting a signal from MVCU 110 to communication network 142.

Telematics unit 120 includes a digital signal processor (DSP) 122 connected to a wireless modem 124, a global positioning system (GPS) unit 126, an in-vehicle memory 128, a microphone 130, one or more speakers 132, and an embedded or in-vehicle mobile phone 134. In other embodiments, telematics unit 120 may be implemented without one or more of the above listed components such as, for example, speakers 132. Telematics unit 120 may include additional components not relevant to the present discussion.

In one embodiment, DSP 122 is implemented as a microcontroller, controller, host processor, or vehicle communications processor. In an example, DSP 122 is implemented as an application specific integrated circuit (ASIC). In another embodiment, DSP 122 is implemented as a processor working in conjunction with a central processing unit (CPU) performing the function of a general purpose processor. GPS unit 126 provides longitude and latitude coordinates of the vehicle responsive to a GPS broadcast signal received from one or more GPS satellite broadcast systems (not shown). In-vehicle mobile phone 134 is a cellular-type phone such as, for example, a digital, dual-mode (e.g., analog and digital), dual-band, multi-mode or multi-band cellular phone.

DSP 122 executes various computer programs that control programming and operational modes of electronic and mechanical systems within MVCU 110. DSP 122 controls communications (e.g., call signals) between telematics unit 120, wireless carrier system 140, and call center 170. Additionally, DSP 122 controls reception of communications from satellite broadcast system 146. In one embodiment, a voice-recognition application is installed in DSP 122 that can translate human voice input through microphone 130 to digital signals. DSP 122 generates and accepts digital signals transmitted between telematics unit 120 and a vehicle communication network 112 that is connected to various electronic modules in the vehicle. In one embodiment, these digital signals activate the programming mode and operation modes, as well as provide for data transfers such as, for example, data over voice channel communication. In this embodiment, signals from DSP 122 are translated into voice messages and sent out through speaker 132.

Wireless carrier system 140 is a wireless communications carrier or a mobile telephone system and transmits to and receives signals from one or more MVCU 110. Wireless carrier system 140 incorporates any type of telecommunications in which electromagnetic waves carry signal over part of or the entire communication path. In one embodiment, wireless carrier system 140 is implemented as any type of broadcast communication in addition to satellite broadcast system 146. In another embodiment, wireless carrier system 140 provides broadcast communication to satellite broadcast system 146 for download to MVCU 110. In an example, wireless carrier system 140 connects communication network 142 to land network 144 directly. In another example, wireless carrier system 140 connects communication network 142 to land network 144 indirectly via satellite broadcast system 146.

Satellite broadcast system 146 transmits radio signals to telematics unit 120 within MVCU 110. In one embodiment, satellite broadcast system 146 may broadcast over a spectrum in the “S” band (2.3 GHz) that has been allocated by the U.S. Federal Communications Commission (FCC) for nationwide broadcasting of satellite-based Digital Audio Radio Service (DARS).

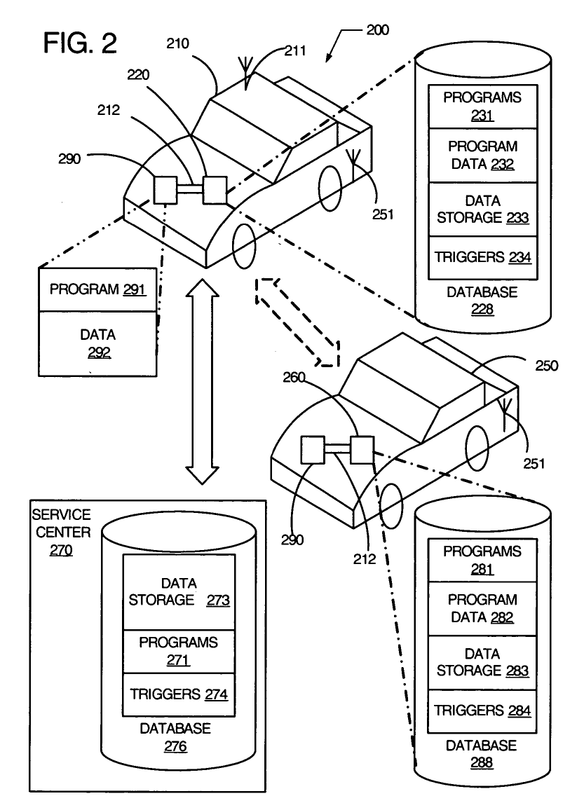

In operation, broadcast services provided by satellite broadcast system 146 are received by telematics unit 120 located within MVCU 110. In one embodiment, broadcast services include various formatted programs based on a package subscription obtained by the user and managed by telematics unit 120. In another embodiment, broadcast services include various formatted data packets based on a package subscription obtained by the user and managed by call center 170. In an example, data packets received by telematics unit 120 are implemented by DSP 122. In another example, data packets received by telematics unit 120 are communicated (see FIG. 2 and discussion, below) to modified MVCUs within the MVCS.

Communication network 142 includes services from one or more mobile telephone switching offices and wireless networks. Communication network 142 connects wireless carrier system 140 to land network 144. Communication network 142 is implemented as any suitable system or collection of systems for connecting wireless carrier system 140 to MVCU 110 and land network 144.

Land network 144 connects communication network 142 to client computer 150, web-hosting portal 160, and call center 170. In one embodiment, land network 144 is a public-switched telephone network (PSTN). In another embodiment, land network 144 is implemented as an Internet protocol (IP) network. In other embodiments, land network 144 is implemented as a wired network, an optical network, a fiber network, other wireless networks, or any combination thereof. Land network 144 is connected to one or more landline telephones. Communication network 142 and land network 144 connect wireless carrier system 140 to web-hosting portal 160 and call center 170.

Client, personal, or user computer 150 includes a computer usable medium to execute Internet browser and Internet-access computer programs for sending and receiving data over land network 144 and, optionally, wired or wireless communication networks 142 to web-hosting portal 160. Personal or client computer 150 sends user preferences to web-hosting portal 160 through a web-page interface using communication standards such as hypertext transport protocol (HTTP), and transport-control protocol and Internet protocol (TCP/IP). In one embodiment, the data includes directives to change certain programming and operational modes of electronic and mechanical systems within MVCU 110.

In operation, a client utilizes computer 150 to initiate setting or re-setting of user preferences for MVCU 110. In an example, a client utilizes computer 150 to provide radio station presets as user preferences for MVCU 110. User-preference data from client-side software is transmitted to server-side software of web-hosting portal 160. In an example, user-preference data is stored at web-hosting portal 160.

Web-hosting portal 160 includes one or more data modems 162, one or more web servers 164, one or more databases 166, and a network system 168. Web-hosting portal 160 is connected directly by wire to call center 170, or connected by phone lines to land network 144, which is connected to call center 170. In an example, web-hosting portal 160 is connected to call center 170 utilizing an IP network. In this example, both components, web-hosting portal 160 and call center 170, are connected to land network 144 utilizing the IP network. In another example, web-hosting portal 160 is connected to land network 144 by one or more data modems 162. Land network 144 sends digital data to and receives digital data from modem 162, data that is then transferred to web server 164. Modem 162 may reside inside web server 164. Land network 144 transmits data communications between web-hosting portal 160 and call center 170.

Web server 164 receives user-preference data from user computer 150 via land network 144. In alternative embodiments, computer 150 includes a wireless modem to send data to web-hosting portal 160 through a wireless communication network 142 and a land network 144. Data is received by land network 144 and sent to one or more web servers 164. In one embodiment, web server 164 is implemented as any suitable hardware and software capable of providing web services to help change and transmit personal preference settings from a client at computer 150 to telematics unit 120 in MVCU 110. Web server 164 sends to or receives from one or more databases 166 data transmissions via network system 168. Web server 164 includes computer applications and files for managing and storing personalization settings supplied by the client, such as door lock/unlock behavior, radio station preset selections, climate controls, custom button configurations and theft alarm settings. For each client, the web server potentially stores hundreds of preferences for wireless vehicle communication, networking, maintenance and diagnostic services for a mobile vehicle.

In one embodiment, one or more web servers 164 are networked via network system 168 to distribute user-preference data among its network components such as database 166. In an example, database 166 is a part of or a separate computer from web server 164. Web server 164 sends data transmissions with user preferences to call center 170 through land network 144.

Call center 170 is a location where many calls are received and serviced at the same time, or where many calls are sent at the same time. In one embodiment, the call center is a telematics call center, facilitating communications to and from telematics unit 120 in MVCU 110. In an example, the call center is a voice call center, providing verbal communications between an advisor in the call center and a subscriber in a mobile vehicle. In another example, the call center contains each of these functions. In other embodiments, call center 170 and web-hosting portal 160 are located in the same or different facilities.

Call center 170 contains one or more voice and data switches 172, one or more communication services managers 174, one or more communication services databases 176, one or more communication services advisors 178, and one or more network systems 180.

Switch 172 of call center 170 connects to land network 144. Switch 172 transmits voice or data transmissions from call center 170, and receives voice or data transmissions from telematics unit 120 in MVCU 110 through wireless carrier system 140, communication network 142, and land network 144. Switch 172 receives data transmissions from and sends data transmissions to one or more web-hosting portals 160. Switch 172 receives data transmissions from or sends data transmissions to one or more communication services managers 174 via one or more network systems 180.

Communication services manager 174 is any suitable hardware and software capable of providing requested communication services to telematics unit 120 in MVCU 110. Communication services manager 174 sends to or receives from one or more communication services databases 176 data transmissions via network system 180. Communication services manager 174 sends to or receives from one or more communication services advisors 178 data transmissions via network system 180. Communication services database 176 sends to or receives from communication services advisor 178 data transmissions via network system 180. Communication services advisor 178 receives from or sends to switch 172 voice or data transmissions.

Communication services manager 174 provides one or more of a variety of services including initiating data over voice channel wireless communication, enrollment services, navigation assistance, directory assistance, roadside assistance, business or residential assistance, information services assistance, emergency assistance, and communications assistance. Communication services manager 174 receives service-preference requests for a variety of services from the client via computer 150, web-hosting portal 160, and land network 144. Communication services manager 174 transmits user-preference and other data such as, for example primary diagnostic script to telematics unit 120 in MVCU 110 through wireless carrier system 140, communication network 142, land network 144, voice and data switch 172, and network system 180. Communication services manager 174 stores or retrieves data and information from communication services database 176. Communication services manager 174 may provide requested information to communication services advisor 178.

In one embodiment, communication services advisor 178 is implemented as a real advisor. In an example, a real advisor is a human being in verbal communication with a user or subscriber (e.g., a client) in MVCU 110 via telematics unit 120. In another embodiment, communication services advisor 178 is implemented as a virtual advisor. In an example, a virtual advisor is implemented as a synthesized voice interface responding to requests from telematics unit 120 in MVCU 110.

Communication services advisor 178 provides services to telematics unit 120 in MVCU 110. Services provided by communication services advisor 178 include enrollment services, navigation assistance, real-time traffic advisories, directory assistance, roadside assistance, business or residential assistance, information services assistance, emergency assistance, automated vehicle diagnostic function, and communications assistance. Communication services advisor 178 communicates with telematics unit 120 in MVCU 110 through wireless carrier system 140, communication network 142, and land network 144 using voice transmissions, or through communication services manager 174 and switch 172 using data transmissions. Switch 172 selects between voice transmissions and data transmissions.

In operation, an incoming call is routed to telematics unit 120 within mobile vehicle 110 from call center 170. In one embodiment, the call is routed to telematics unit 120 from call center 170 via land network 144, communication network 142, and wireless carrier system 140. In another embodiment, an outbound communication is routed to telematics unit 120 from call center 170 via land network 144, communication network 142, wireless carrier system 140 and satellite broadcast system 146. In this embodiment, an inbound communication is routed to call center 170 from telematics unit 120 via wireless carrier system 140, communication network 142, and land network 144.

FIG. 2 is a block diagram of a telematics based system in accordance with an embodiment of the present invention. FIG. 2 shows a telematics based system 200 for operating a vehicle telematics device as a communication gateway.

In FIG. 2, the system includes a primary mobile vehicle 210, a secondary mobile vehicle 250, and a service provider 270 such as, for example, a call center, a service center, and the like. Primary mobile vehicle 210 includes a telematics unit 220 coupled to one or more vehicle system modules 290 via a vehicle communication network 212. Primary mobile vehicle 210 additionally includes a primary antenna 211 and a secondary antenna 251. Primary antenna 211 is coupled (not shown) to telematics unit 220 to communicate with a wireless carrier system as well as receive wireless communication from a satellite broadcast system. Secondary antenna 251 is coupled (not shown) to telematics unit 220 to communicate with wireless access points (e.g., wireless modem unit 260 of secondary mobile vehicle 250) utilizing short range communication protocol as described below. In another embodiment, the functionality of primary antenna 211 and secondary antenna 251 is combined and performed by primary antenna 211.

Secondary mobile vehicle 250 includes a wireless modem unit 260 coupled to one or more vehicle system modules 290 via a vehicle communication network 212. Secondary mobile vehicle 250 additionally includes a secondary antenna 251. Secondary antenna 251 is coupled (not shown) to wireless modem unit 260 to communicate with a communication gateway (e.g., telematics unit 220 of primary mobile vehicle 210) utilizing a short range communication protocol. In one embodiment, the short range communication protocol is a short range wireless communication protocol such as, for example, 802.11 series or Bluetooth® as is known in the art. In an example, the short range wireless communication protocol is an 802.11 series such as, for example, Wi-Fi, direct-sequence spread spectrum (DFSS), frequency-hopping spread spectrum (FHSS), or shared wireless access protocol (SWAP).

Telematics unit 220 further includes a database 228 that contains programs 231, program data 232, data storage 233 and triggers 234. A vehicle system module (VSM) 290 is included within primary mobile vehicle 210 as well as secondary mobile vehicle 250 and each further includes a program 291 and data 292. In one embodiment, VSM 290 within primary mobile vehicle 210 is located within telematics unit 220. Vehicle system module (VSM) 290 within secondary mobile vehicle 250 functions as described below with respect to primary mobile vehicle 210. Wireless modem unit 260 further includes a database 288 that contains programs 281, program data 282, data storage 283, and triggers 284. In one embodiment, VSM 290 is in communication with wireless modem unit 260. Service provider 270 further includes a database 276 that contains programs 271, data storage 273, and triggers 274. In FIG. 2, the elements are presented for illustrative purposes and are not intended to be limiting. Telematics-based system 200 may include additional components not relevant to the present discussion.

Telematics unit 220 is any telematics device enabled for operation with a telematics service provider such as, for example, telematics unit 120 as described with reference to FIG. 1. Telematics unit 220 in vehicle 210 is in communication with service provider 270 (e.g., a “service center”). In one embodiment, data communicated between service provider 270 and telematics unit 220 is pre-packaged at service provider 270 for compatibility with a wireless access point protocol. In an example, the data is pre-packaged utilizing a cellular packet protocol such as, for example, Single Carrier Radio Transmission Technology (1XRTT) or Evolution Data Only (EvDO). Telematics unit 220 includes volatile and non-volatile memory components for storing data and programs. In one embodiment, memory components in telematics unit 220 contain database 228.

Database 228 includes one or more programs 231 for operating telematics unit 220, for example, for operating a vehicle telematics device as a communication gateway. In operation, program 231 receives instructions and data in the form of a data stream from service provider 270 at data storage 233. Program 231 executes the instructions such as, for example, by parsing the data stream for additional instructions as well as data and triggers. In one embodiment, program 231 parses the data stream and stores triggers at triggers 234 and transfers data to VSM 290 for execution. In another embodiment, program 231 parses the data stream and sends data to secondary antenna 251 for transmission to secondary mobile vehicle 250 for execution.

Wireless modem unit 260 is any wireless modem device enabled for operation with a communication gateway such as, for example, telematics unit 220 as described above. Wireless modem unit 260, in secondary mobile vehicle 250, is in communication with telematics unit 220 within primary mobile vehicle 210. Wireless modem unit 260 includes volatile and non-volatile memory components for storing data and programs. In one embodiment, memory components in wireless modem unit 260 contain database 288.

Database 288 includes one or more programs 281 for operating wireless modem unit 260, for example, for operating a vehicle wireless modem unit as a wireless access point. In operation, program 281 receives instructions and data in the form of a data stream from telematics unit 220 of primary mobile vehicle 210 via antenna 251 at data storage 283. Program 281 executes the instructions such as, for example, by parsing the data stream for additional instructions as well as data and triggers. In one embodiment, program 281 parses the data stream and stores triggers at triggers 284 and transfers data to VSM 290 for execution. In an example, program 281 executes the instructions immediately upon reception of the data stream. In another example, program 281 executes the instructions at a predetermined time such as when a predetermined event occurs, for example, upon activation of a trigger located in triggers 284. Examples of instructions and associated data included within the data stream include a diagnostic test script, a vehicle system software update, and the like.

Vehicle system module (VSM) 290 is any vehicle system control module having software and hardware components for operating, controlling or monitoring one or more vehicle systems. In one embodiment, VSM 290 is a sensor and provides diagnostic data collected from primary mobile vehicle 210. In another embodiment, VSM 290 is a sensor and provides diagnostic data collected from secondary mobile vehicle 250. In yet another embodiment, VSM 290 is a global positioning system (GPS) module such as, for example, GPS unit 126 of FIG. 1, and provides location information to complement diagnostic data collected from primary mobile vehicle 210.

Vehicle system module 290 contains one or more processors, one or more memory devices, and one or more connection ports. In one embodiment, VSM 290 includes a software switch for scanning received information such as, for example, sensor information to identify that data has been received. VSM 290 is coupled to a vehicle communication network 212, and therefore to any other device that is also coupled to vehicle communication network 212.

In one embodiment, VSM 290 is directly coupled to telematics unit 220 in primary mobile vehicle 210, for example, vehicle communication network 212 coupling telematics unit 220 to vehicle system module 290. In another embodiment, VSM 290 is directly coupled to wireless modem unit 260 in secondary mobile vehicle 250, for example, vehicle communication network 212 coupling wireless modem unit 260 to vehicle system module 290. In an example, vehicle communication network 212 is a vehicle communication network 112 as described in FIG. 1, above. In another embodiment, VSM 290 is indirectly coupled to telematics unit 220.

Service provider 270 is any service center providing telematics services, such as service center 170 described with reference to FIG. 1. In one embodiment, service provider 270 includes hardware and software for managing database 276. In another embodiment, service center 270 is configured to access a database that is in another location but coupled to service center 270 such as, for example, database 166 in web server 160 as described in FIG. 1. Service provider 270 manages the configuring and delivery of a data stream to primary mobile vehicle 210 and to secondary mobile vehicle 250 via primary mobile vehicle 210 acting as a communication gateway.

Database 276 contains data stored at data storage 273 and trigger data stored at triggers 274. In one embodiment, database 276 includes one or more programs 271 for managing operation of a mobile vehicle communication system (MVCS) such as, for example, MVCS 100 in FIG. 1, above. In this embodiment, database 276 includes one or more programs 271 for managing a MVCS, including the operating of a vehicle telematics device as a communication gateway within the MVCS. In an example, the gateway serves to communicate software updates to a plurality of vehicles in a storage facility. The trigger is, for example, notification to service center 270 from telematics unit 220 of an identification of wireless modem unit 260. In this example, the trigger then initiates one or more programs 271 for managing operation of a mobile vehicle communication system (MVCS) based on the trigger.

In operation, telematics unit 220 detects a wireless access point (e.g., wireless modem unit 260) and establishes a communication gateway, utilizing telematics unit 220, between the detected wireless access point and service provider 270. Data is then communicated between the wireless access point and the service provider via the communication gateway. In an example and referring to FIGS. 1 and 2 above, during communication telematics unit 220 communicates with wireless modem unit 260 utilizing short range communication protocol. In this example, during communication telematics unit 120, 220 communicates with service provider 270/call center 170. In one embodiment, communication between telematics unit 120/220 and service provider 270/call center 170 is conducted as described in FIG. 1, above. The communication via the communication gateway allows the service provider/call center to access an otherwise potentially inaccessible mobile vehicle utilizing the mobile vehicle's wireless modem unit.

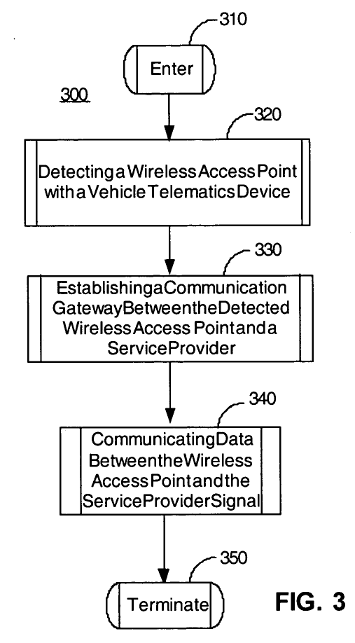

FIG. 3 is a flow diagram of one embodiment of a method of operating a vehicle telematics device as a communication gateway. In FIG. 3, method 300 may utilize one or more systems and concepts detailed in FIGS. 1 and 2, above. The present invention can also take the form of a computer usable medium including a program for configuring an electronic module within a vehicle. The program stored in the computer usable medium includes computer program code for executing the method steps described in FIG. 3. In FIG. 3, method 300 begins at step 310.

At step 320, a wireless access point is detected with a vehicle telematics device. In one embodiment, detecting the wireless access point includes receiving a transmission from a wireless modem unit. In an example and referring to FIG. 2 above, telematics unit 220 detects wireless modem unit 260 by receiving a transmission from wireless modem unit 260. In another embodiment, detecting the wireless access point includes transmitting a polling message from the vehicle telematics device and receiving a response, generated by the wireless access point, to the polling message. In an example and referring to FIG. 2 above, telematics unit 220 detects wireless modem unit 260 by transmitting a polling message from telematics unit 220 and receiving a response, generated by wireless modem unit 260, to the polling message.

At step 330, a communication gateway is established, utilizing the vehicle telematics device, between the detected wireless access point and a service provider. In one embodiment, establishing the communication gateway between the detected wireless access point and the service provider utilizing the vehicle telematics device includes receiving identification information from the detected wireless access point, transmitting the received identification information to the service provider for authentication, receiving a data stream for the wireless access point from the service provider, and transmitting the received data stream to the wireless access point. In an example and referring to FIG. 2 above, establishing the communication gateway between the detected wireless modem unit 260 and the service provider 270 utilizing vehicle telematics unit 220 includes receiving identification information at telematics unit 220 from the detected wireless modem unit 260, transmitting the received identification information from telematics unit 220 to the service provider 270 for authentication, receiving a data stream to telematics unit 220 for wireless modem unit 260 from the service provider 270, and transmitting the received data stream from telematics unit 220 to the wireless access point.

In another embodiment, establishing the communication gateway between the detected wireless access point and the service provider further includes receiving a data stream having instructions for the communication gateway from the service provider and implementing the received instructions.

In yet another embodiment, establishing the communication gateway between the detected wireless access point and the service provider includes establishing communication between the communication gateway and the detected wireless access point utilizing a first communication protocol, and establishing communication between the communication gateway and the service provider utilizing a second communication protocol. In an example, the first communication protocol and second communication protocol are a short range wireless communication protocol such as, for example, 802.11 series or Bluetooth® as is known in the art. In this example, the short range wireless communication protocol is an 802.11 series such as, for example, Wi-Fi, direct-sequence spread spectrum (DFSS), frequency-hopping spread spectrum (FHSS), or shared wireless access protocol (SWAP). In one embodiment, the first and second communication protocols are different protocols. In one embodiment, the communication protocol is any communication protocol in accord with FCC Part 15.

At step 340, data is communicated between the wireless access point and the service provider via the communication gateway. In one embodiment, the data is pre-packaged at the service provider for compatibility with a wireless access point protocol. In an example, the data is pre-packaged utilizing a cellular packet protocol such as, for example, Single Carrier Radio Transmission Technology (1XRTT) and Evolution Data Only (EvDO).

At step 350, the method is terminated.

The above-described methods and implementation for operating a vehicle telematics device as a communication gateway are example methods and implementations. These methods and implementations illustrate one possible approach for operating a vehicle telematics device as a communication gateway. The actual implementation may vary from the method discussed. Moreover, various other improvements and modifications to this invention may occur to those skilled in the art, and those improvements and modifications will fall within the scope of this invention as set forth in the claims below.

The present invention may be embodied in other specific forms without departing from its spirit or essential characteristics. The described embodiments are to be considered in all respects only as illustrative and not restrictive.

1. A method of operating a vehicle telematics device as a communication gateway, comprising:
detecting a wireless access point with a vehicle telematics device;
establishing a communication gateway between the detected wireless access point and a service provider utilizing the vehicle telematics device; and
communicating data between the wireless access point and the service provider via the communication gateway.

2. The method of claim 1, wherein detecting the wireless access point comprises receiving a transmission from a wireless modem unit.

3. The method of claim 1, wherein detecting the wireless access point comprises:
transmitting a polling message; and
receiving a response to the polling message, the response generated by the wireless access point.

4. The method of claim 1, wherein establishing the communication gateway between the detected wireless access point and the service provider comprises:
receiving identification information from the detected wireless access point;
transmitting the received identification information to the service provider for authentication;
receiving a data stream for the wireless access point from the service provider; and
transmitting the received data stream to the wireless access point.

5. The method of claim 4, further comprising:
receiving a data stream for the communication gateway from the service provider, the data stream including instructions for the communication gateway; and
implementing the received instructions.

6. The method of claim 1, wherein establishing the communication gateway between the detected wireless access point and the service provider comprises:
establishing communication between the communication gateway and the detected wireless access point utilizing a first communication protocol; and
establishing communication between the communication gateway and the service provider utilizing a second communication protocol.

7. The method of claim 6, wherein the first communication protocol is selected from the group consisting of: 802.11 series, Bluetooth, Wi-Fi, direct-sequence spread spectrum, frequency-hopping spread spectrum, and shared wireless access protocol.

8. The method of claim 6 wherein the first communication protocol is a FCC Part 15 protocol.

9. The method of claim 1, wherein the data is pre-packaged at the service provider for compatibility with a wireless access point protocol.

10. A computer readable medium storing a computer program comprising:
computer readable code for detecting a wireless access point with a vehicle telematics device;
computer readable code for establishing a communication gateway between the detected wireless access point and a service provider utilizing the vehicle telematics device; and
computer readable code for communicating data between the wireless access point and the service provider via the communication gateway.

11. The computer readable medium of claim 10, wherein the computer readable code for detecting the wireless access point comprises computer readable code for directing the reception of a transmission from the wireless access point.

12. The computer readable medium of claim 10, wherein the computer readable code for detecting the wireless access point comprises:
computer readable code for directing the transmission of a polling message; and
computer readable code for directing the reception of a response to the polling message, the response generated by the wireless access point.

13. The computer readable medium of claim 10, wherein the computer readable code for establishing the communication gateway between the detected wireless access point and the service provider comprises:
computer readable code for directing the reception of identification information from the detected wireless access point;
computer readable code for directing the transmission of the received identification information to the service provider for authentication;
computer readable code for directing the reception of a data stream for the wireless access point from the service provider; and
computer readable code for directing the transmission of the received data stream to the wireless access point.

14. The computer readable medium of claim 13, further comprising:
computer readable code for directing the reception of a data stream for the communication gateway from the service provider, the data stream including instructions for the communication gateway; and
computer readable code for implementing the received instructions.

15. The computer readable medium of claim 10, wherein the computer readable code for establishing the communication gateway between the detected wireless access point and the service provider comprises
computer readable code for establishing communication between the communication gateway and the detected wireless access point utilizing a first communication protocol; and
computer readable code for establishing communication between the communication gateway and the service provider utilizing a second communication protocol.

16. The computer readable medium of claim 15, wherein the first communication protocol is selected from the group consisting of: 802.11 series, Bluetooth, Wi-Fi, direct-sequence spread spectrum, frequency-hopping spread spectrum, and shared wireless access protocol.

17. The computer readable medium of claim 15, wherein the first communication protocol is a FCC Part 15 protocol.

18. The computer readable medium of claim 10, wherein the data is pre-packaged at the service provider for compatibility with a wireless access point protocol.

19. A system for operating a vehicle telematics device as a communication gateway, comprising:
means for detecting a wireless access point with a vehicle telematics device;
means for establishing a communication gateway between the detected wireless access point and a service provider utilizing the vehicle telematics device; and
means for communicating data between the wireless access point and the service provider via the communication gateway.
